(19) United States
(12) Patent Application Publication
(10) Pub. No.: US 2012/0041996 A1
(43) Pub. Date: Feb. 16, 2012

(54) Parallel pipelined systems for computing the fast fourier transform

(75) Inventors: Manohar Ayinala, Minneapolis, MN (US); Michael J. Brown, Coon Rapids, MN (US); Keshab K. Parhi, Maple Grove, MN (US)

(73) Assignee: Leanics Corporation

(21) Appl. No.: 13/136,927

(22) Filed: Aug. 15, 2011

Related U.S. Application Data
(60) Provisional application No. 61/401,552, filed on Aug. 16, 2010.

(51) Int. Cl. G06F 17/14

(52) U.S. Cl. 708/404

(57) ABSTRACT

The present invention relates to the design and implementation of parallel pipelined circuits for the fast Fourier transform (FFT). In this invention, an efficient way of designing FFT circuits using folding transformation and register minimization techniques is proposed. Based on the proposed scheme, novel parallel-pipelined architectures for the computation of complex fast Fourier transform are derived. The proposed architecture takes advantage of under utilized hardware in the serial architecture to derive L-parallel architectures without increasing the hardware complexity by a factor of L. The proposed circuits process L consecutive samples from a single-channel signal in parallel. The operating frequency of the proposed architecture can be decreased which in turn reduces the power consumption. The proposed scheme is general and suitable for applications such as communications, biomedical monitoring systems, and high speed OFDM systems.

### CROSS-REFERENCE TO RELATED APPLICATIONS

This application claims the benefit of U.S. Provisional Application No. 61/401,552, filed on Aug. 16, 2010, the entire content of which is incorporated herein by reference in its entirety.

### FIELD OF THE INVENTION

The present invention relates to digital signal processing and computation of discrete Fourier transform. More specifically, it relates to high speed and/or low power designs of fast fourier transform (FFT) circuits based on radix-2ⁿ algorithms.

### BACKGROUND OF THE INVENTION

Fast Fourier Transform (FFT) is one of the most important algorithms in the field of digital signal processing, used to efficiently compute discrete fourier transform. Pipelined hardware FFT designs play an important role in real-time applications. In biomedical applications, the power spectral density (PSD) of various signals such as electrocardiography (ECG) or electroencephalography (EEG) need to be estimated. Further, FFT is a key element in Orthogonal Frequency Division Multiplexing (OFDM) based communication technologies such as Wireless LAN, WiMAX, ADSL, VDSL, DVB-T.

Apart from high-speed of operation, these applications demand low power consumption since it is primarily aimed at portable and mobile applications. The most computationally intensive parts of such systems are the fast Fourier transform (FFT). FFT operation has been proven to be both computationally intensive, in terms of arithmetic operations and communicational intensive, in terms of data swapping in the storage. Therefore, efficient implementation of these FFT circuits is very important for successful low power applications.

As will be understood by persons skilled in the relevant arts, FFT circuits are designed, for example, using pipelining and parallelism techniques. These known techniques have enabled engineers to build spectral processing systems and wireless communication systems, using available technologies, which operate at data rates in excess of 1 Gb/s. These known techniques, however, cannot always be applied successfully to the design of low-power and/or high speed systems. Applying these techniques is particularly difficult when dealing with FFT circuits.

The use of pipelining and parallelism techniques, for example, for FFT circuits is known. However, there are several approaches that can be used in applying parallelism technique in the context of FFT circuit, for example, the FFT circuit in a communication transceiver. Many of these approaches may improve the performance of the digital circuit to which they are applied, but degrade the circuit performance in terms of power consumption.

There is a current need for new design techniques and digital logic circuits that can be used to build high-speed digital communication systems and low-power spectral processing systems. In particular, new design methodology and an implementation method are needed which can reduce the overall power consumption and hardware cost of implementing these FFT circuits.

### BRIEF SUMMARY OF THE INVENTION

Digital circuits and methods for designing digital circuits that determine output values based on plurality of input values are provided. As described herein, the present invention can be used in a wide range of applications. The invention is suited for low-power biomedical monitoring systems and high-speed communication systems, although the invention is not limited to just these systems.

The key ideas of the proposed design are the parallel FFT circuits which can process consecutive samples, with continuous usage of hardware elements. The present invention proposes a new method to design FFT circuits and also describes low-power implementation method for the proposed low complexity FFT circuits. Digital circuits are designed in accordance with an embodiment of the invention as follows. A number of samples (L) of an input stream to be processed in parallel by a digital circuit is needed, where L is a power of 2 (i.e., L=2^{k}, k is a positive integer). A clocking rate (C) is selected for the digital circuit which consumes power (P). An initial circuit capable of serially processing the samples of the input stream with power consumption P is formed which computes an N-point FFT. N is a whole number greater than zero, in general is a power of two. The data flow graph of N-point FFT which can process N samples in parallel is designed. The data flow graph is retimed and/or pipelined to achieve the folding factor L. The data flow graph is folded by a factor of L to form L parallel circuit processing the input samples.

In accordance with the present invention, the overall hardware cost reduction in FFT circuits is achieved by using the proposed design. Applying the folding technique (See, e.g., M. Ayinala, M. Brown and K. K. Parhi, “Pipelined Parallel FFT Architectures via Folding Transformation,” in IEEE Trans. VLSI Systems, 2011), FFT circuits are designed with reduced hardware cost.

In an embodiment, the data flow graph is folded to form at least two parallel processing circuits that are interconnected.

In an embodiment, the digital logic circuit according to the invention forms a part of transmitter and receiver circuits in an OFDM system. The invention can be used in Wireless LAN devices.

In an embodiment, the digital logic circuit according to the invention forms a spectral power computation unit. The invention can be used in biomedical monitoring devices.

Further embodiments, features, and advantages of the present invention, as well as the structure and operation of the various embodiments of the present invention are described in detail below with reference to accompanying drawings.

### BRIEF DESCRIPTION OF THE DRAWINGS/FIGURES

The present invention is described with reference to the accompanying figures. The accompanying figure, which are incorporated herein, form part of the specification, illustrate the present invention and, together with the description, further serve to explain the principles of the invention and to enable a person skilled in the relevant art to make and use the invention.

FIG. 1 illustrates the circuit for N=16 point FFT using radix-2 algorithm.

FIG. 2 illustrates the circuit for N=16 point FFT using radix-2 algorithm with low hardware complexity.

FIG. 3 illustrates the circuit for N=16 point FFT using radix-2² algorithm.

FIG. 4 illustrates the flow graph of a radix-2 16-point DIF FFT.

FIG. 5 illustrates the switch circuit which is a part of FFT circuit.

FIG. 6 illustrates the bufferfly engine in a 2-parallel circuit.

FIG. 7 illustrates the bufferfly engine in a L-parallel circuit.

FIG. 8 illustrates the data flow graph of a method for pipelining the FFT that form an integrated circuit according to an embodiment of the invention.

FIG. 9 illustrates a 2-parallel representation of a 16-point radix-2 DIF FFT architecture according to the invention.

FIG. 10 illustrates the data flow graph of a method for pipelining the DIT FFT that form an integrated circuit according to an embodiment of the invention.

FIG. 11 illustrates a 2-parallel representation of a 16-point radix-2 DIF FFT architecture according to the invention.

FIG. 12 illustrates the data flow graph of a method for pipelining the FFT that form an integrated circuit according to an embodiment of the invention.

FIG. 13 illustrates a 4-parallel representation of a 16-point radix-2 DIF FFT architecture according to the invention.

FIG. 14 illustrates a 4-parallel representation of a 16-point radix-2 DIT FFT architecture according to the invention.

FIG. 15 illustrates the flow graph of a radix-2² 16-point DIF FFT.

FIG. 16 illustrates a 2-parallel representation of a 16-point radix-2² DIF FFT architecture according to the invention.

FIG. 17 illustrates a 4-parallel representation of a 16-point radix-2² DIF FFT architecture according to the invention.

FIG. 18 illustrates a 2-parallel representation of a 64-point radix-2³ DIF FFT architecture according to the invention.

FIG. 19 illustrates a 2-parallel representation of a modified 64-point radix-2³ DIF FFT architecture according to the invention.

Table 1 lists the performance comparison for different designs in terms of hardware complexity.

### DETAILED DESCRIPTION OF THE INVENTION

### Prior Inventions on FFT Circuits

Fast Fourier Transform (FFT) is widely used in the field of digital signal processing (DSP) such as filtering, spectral analysis etc., to compute the discrete Fourier transform (DFT). FFT plays a critical role in modern digital communications such as digital video broadcasting and orthogonal frequency division multiplexing (OFDM) systems. Various algorithms have been developed to reduce the computational complexity, of which Cooley-Tukey radix-2 FFT is very popular.

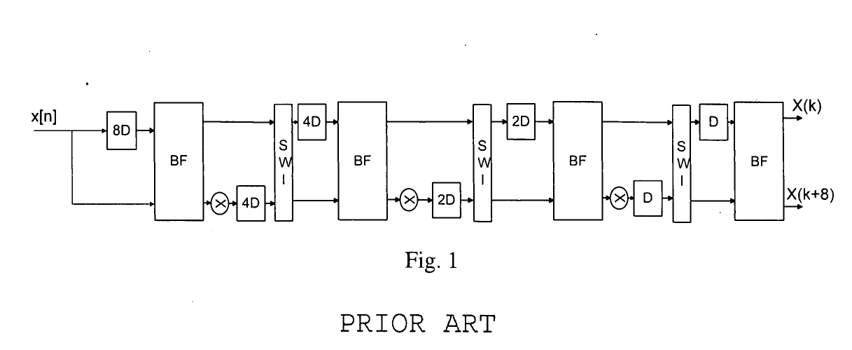

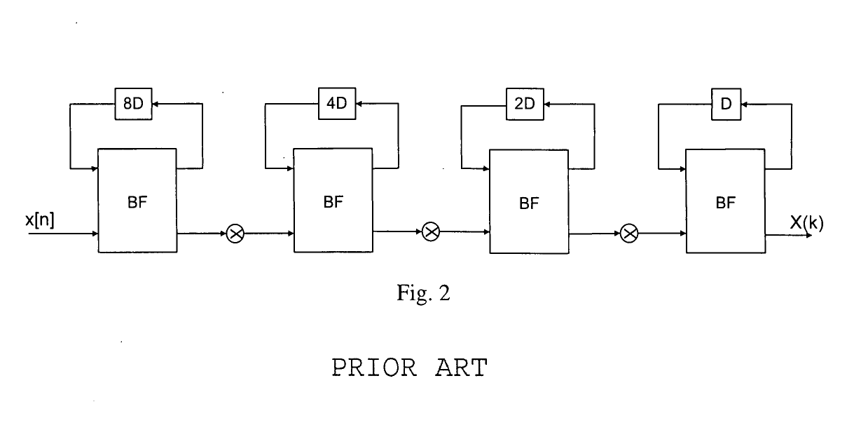

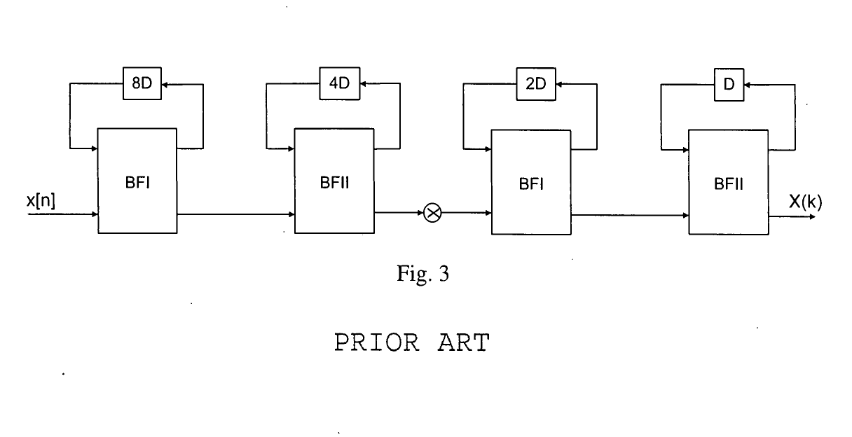

Algorithms including radix-4, split-radix, radix-2² have been developed based on the basic radix-2 FFT approach. The architectures based on these algorithms are some of the traditional FFT circuits. Radix-2 Multi-path delay commutator (R2MDC) is one of the most classical approaches for pipelined implementation of radix-2 FFT is shown in FIG. 1 for N=16. Efficient usage of the storage buffer in R2MDC leads to Radix-2 Single-path delay feedback (R2SDF) architecture with reduced memory. FIG. 2 shows a radix-2 feedback pipelined architecture for N=16 points. R4MDC and R4SDF are proposed as radix-4 versions of R2MDC and R4SDF respectively. Radix-4 single-path delay commutator (R4SDC) is proposed using a modified radix-4 algorithm to reduce the complexity of R4MDC architecture. Similarly, FIG. 3 shows a circuit for N=16 point FFT using radix-2² algorithm. (See, e.g., S. He, M. Torkelson, “Designing pipeline FFT processor for OFDM (de)modulation)”, in International Symposium on Signals, Systems, and Electronics, pp. 257-262, October 1998.

Many FFT circuits have been proposed based on these traditional algorithms which can process L samples in parallel. In one of the previous inventions, a 2-parallel FFT circuit was proposed (See, Jaiganesh Balakrishnan, and Manish Goel, “Methods and Systems for a Multichannel Fast Fourier Transform (FFT)”, U.S. Pat. No. 7,827,225 B2, November 2010). This circuit process samples from two different channels instead of from the same channel. Further, main drawback of prior circuits is that these are not fully utilized which leads to high hardware complexity. In a direct realization of 2-parallel circuit for the one shown in FIG. 1, the hardware complexity doubles compared to the original circuit. That implies, hardware complexity of an L-parallel circuit is L-times the original circuit. This leads to high power consumption. In the era of high speed digital communications, high throughput and low power designs are required to meet the speed and power requirements while keeping the hardware overhead to minimum.

Thus, a new method is needed to design the parallel FFT circuits to reduce the hardware complexity and power consumption. The proposed designs process L-consecutive samples in parallel, where L is a power of 2. Further, the hardware elements of the circuit are utilized 100% of the time.

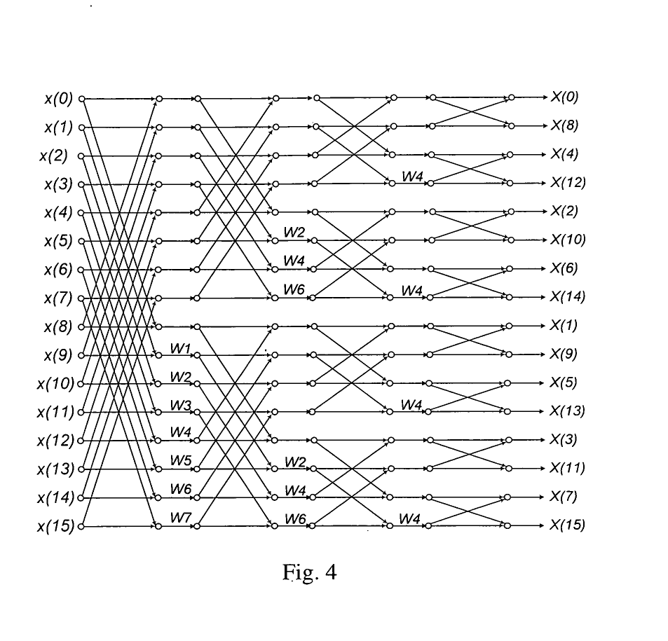

As will be understood by persons skilled in relevant arts, folding transformation can be used to design parallel circuits. Consider a traditional radix-2 algorithm which is shown in the FIG. 4 for N=16. In the folding transformation, all butterflies in the same column can be mapped to one hardware butterfly unit. If the FFT size is N, then this corresponds to a folding factor of N/2. This leads to a 2-parallel architecture. In another design, we can choose a folding factor of N/4 to design a 4-parallel architectures, where 4 samples are processed in the same clock cycle. Different folding sets lead to a family of FFT circuits. Alternatively, known FFT architectures can also be described by the folding methodology by selecting the appropriate folding set. Folding sets are designed intuitively to reduce latency and to reduce the hardware components required.

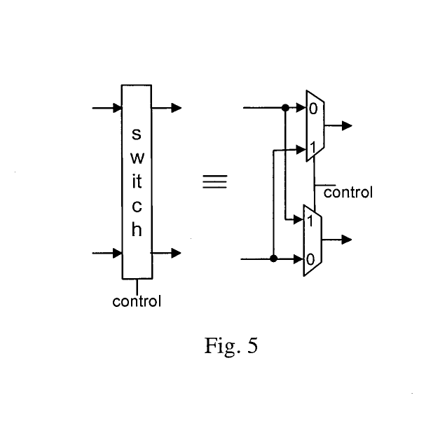

In this invention, parallel FFT circuits for complex valued signals based on radix-2, radix-2² and radix-2³ algorithms. The same approach can be extended to radix-2⁴ and other radices as well. The switch block is as shown in FIG. 5. The control signals for these switches can be generated by using a log₂ N-bit counter. Different output bits of the counter will control the switches in different stages of the FFT.

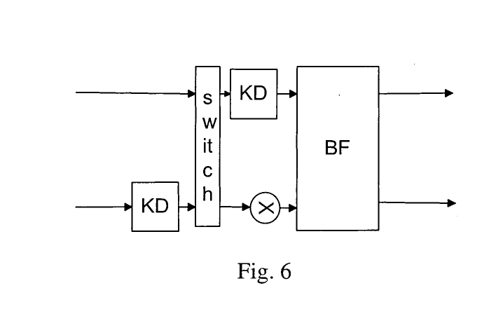

The 2-parallel FFT circuits are composed of radix-2 butterfly engines connected in cascade. Each butterfly engine processes two samples and computes two output samples, and contains a butterfly computation unit as shown in FIG. 6. Further, each butterfly engine contains some K memory elements, where K is a non-negative integer. In an embodiment, memory element can be realized as flip-flop circuit, Random Access Memory (RAM) block or register file.

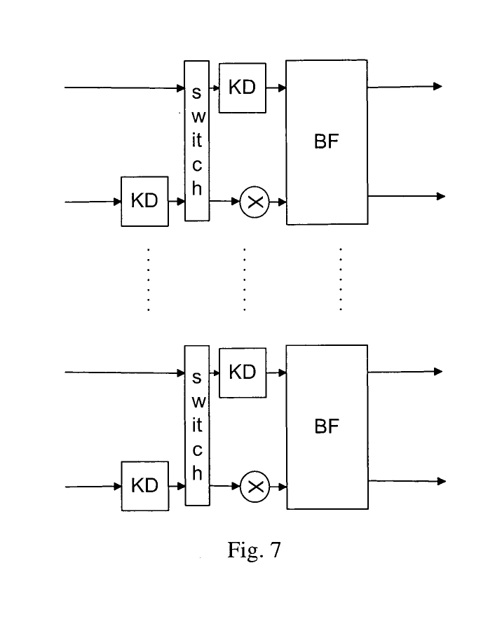

Similarly, FIG. 7 shows an L-parallel radix-2 butterfly engine. This butterfly engine composes of log₂ (L) butterfly computation units in parallel which can process L samples in parallel. It also contains some K memory elements, where K is a nonnegative integer.

### 2-parallel Radix-2 FFT Architecture

The utilization of hardware components in the circuit shown in FIG. 1 is only 50%. New circuits are designed by changing the folding sets which can lead to efficient circuits in terms of hardware utilization and power consumption. One such example of a 2-parallel circuit which leads to 100% hardware utilization and consumes less power.

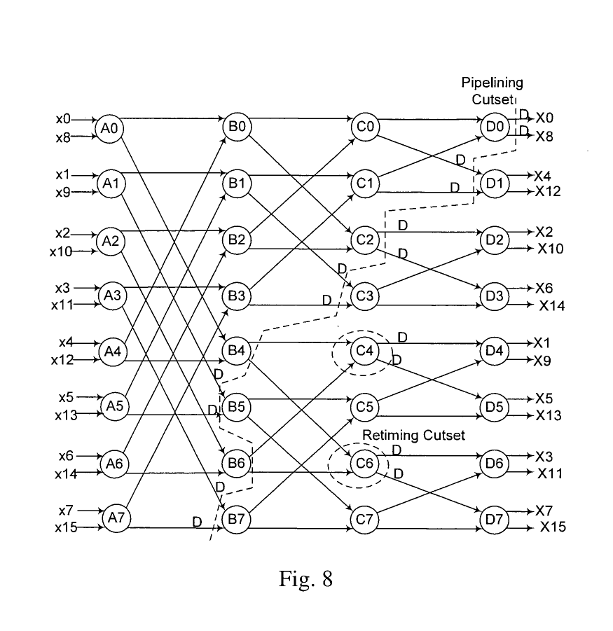

FIG. 8 shows the data flow graph of the radix-2 DIF FFT for N=16. All the nodes in this figure represent radix-2 butterfly operations. Assume the nodes A, B and C contain the multiplier operation at the bottom output of the butterfly. Consider the folding sets

A={A0, A2, A4, A6, A1, A3, A5, A7},

B={B5, B7, B0, B2, B4, B6, B1, B3},

C={C3, C5, C7, C0, C2, C4, C6, C1},

D={D2, D4, D6, D1, D3, D5, D7, D0} (1)

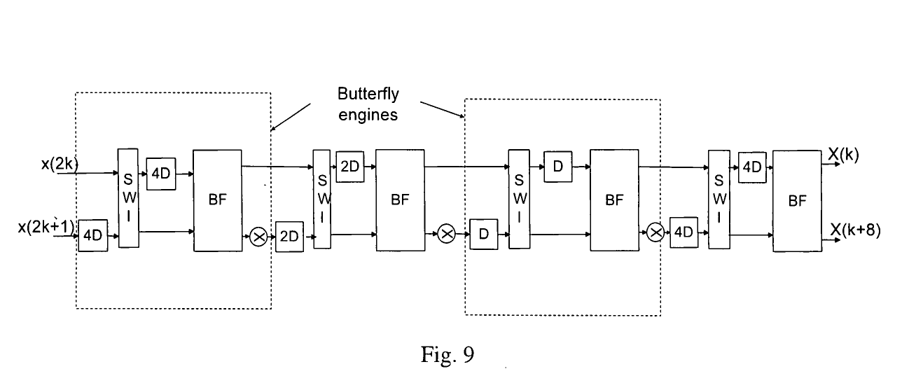

The folded circuit is derived by writing the folding equation for all the edges. Pipelining and retiming are required to get non-negative delays in the folded circuit. The data flow graph in FIG. 8 also shows the retimed delays on some of the edges of the graph. The final folded circuit is shown in FIG. 9. The register minimization techniques and forward-backward register allocation are also applied in deriving this circuit. Note the similarity of the datapath to R2MDC. This architecture processes two input samples at the same time instead of one sample in R2MDC. The implementation uses regular radix-2 butterflies. Due to the spatial regularity of the radix-2 algorithm, the synchronization control of the design is very simple. A log₂ (N)-bit counter serves two purposes: synchronization controller i.e., the control input to the switches, and address counter for twiddle factor selection in each stage.

The hardware utilization is 100% in this circuit. In a general case of N-point FFT, with N power of 2, the architecture requires log₂ (N) complex butterflies, log₂ (N)−1 complex multipliers and 3N/2−2 delay elements or buffers.

In a similar manner, the 2-parallel architecture can be derived for radix-2 DIT FFT using the following folding sets. Assume that multiplier is at the bottom input of the nodes B, C, D.

A={A0, A2, A1, A3, A4, A6, A5, A7},

B={B5, B7, B0, B2, B1, B3, B4, B6},

C={C6, C5, C7, C0, C2, C1, C3, C4},

D={D2, D1, D3, D4, D6, D5, D7, D0}

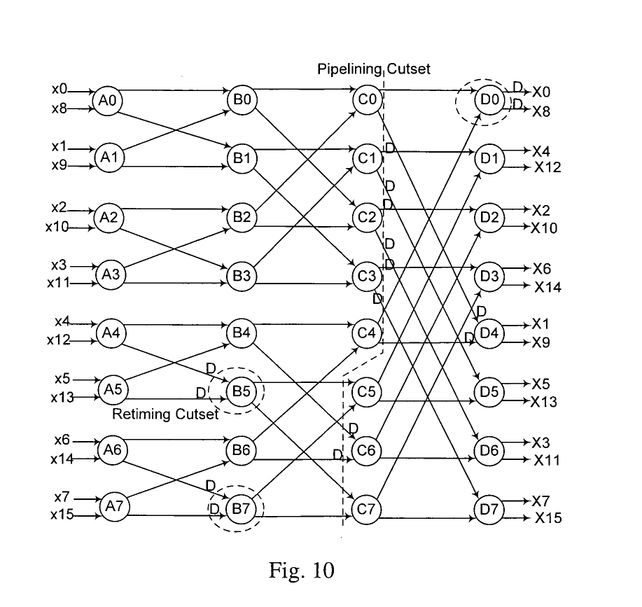

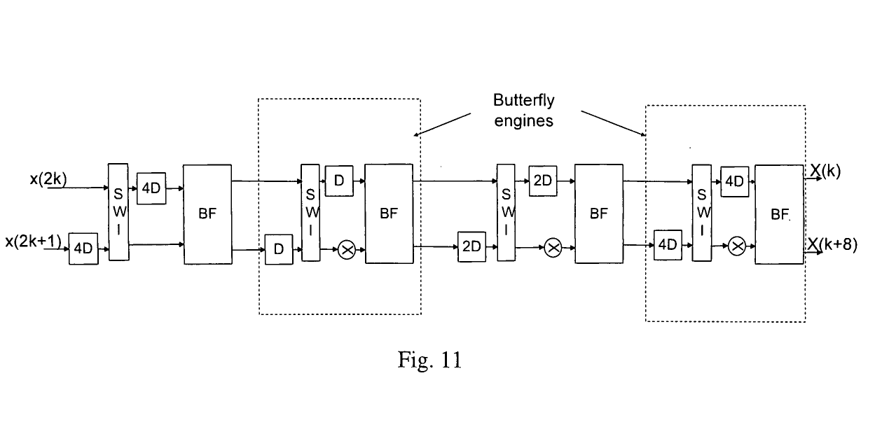

The pipelined/retimed version of the data flow graph is shown in FIG. 10, and the 2-parallel circuit is shown in FIG. 11. The main difference in the two circuits (FIG. 9 and FIG. 11) is the position of the delay elements in between the butterflies.

A 4-parallel architecture can be derived using the following folding sets.

A={A0, A1, A2, A3} A′={A′0, A′1, A′2, A′3},

B={B1, B3, B0, B2} B′={B′1, B′3, B′0, B′2},

C={C2, C1, C3, C0} C′={C′2, C′1, C′3, C′0},

D={D3, D0, D2, D1} D′={D′3, D′0, D′2, D′1}

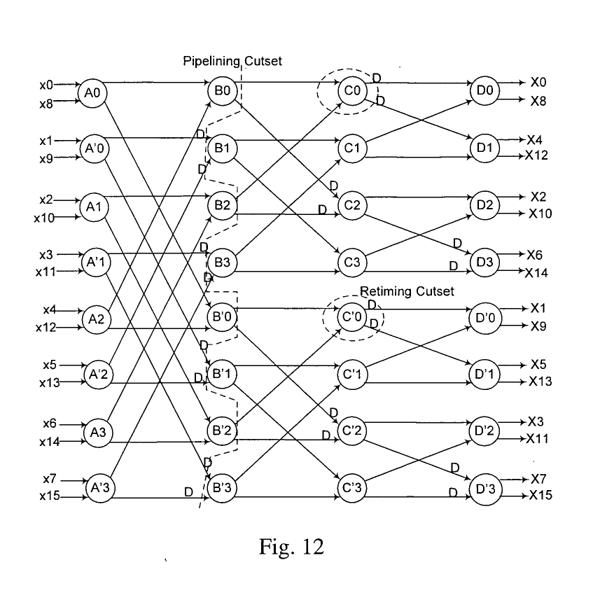

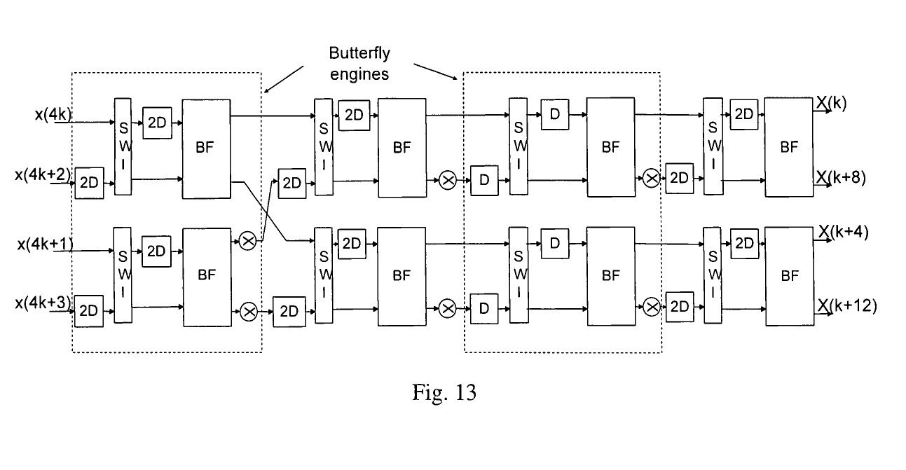

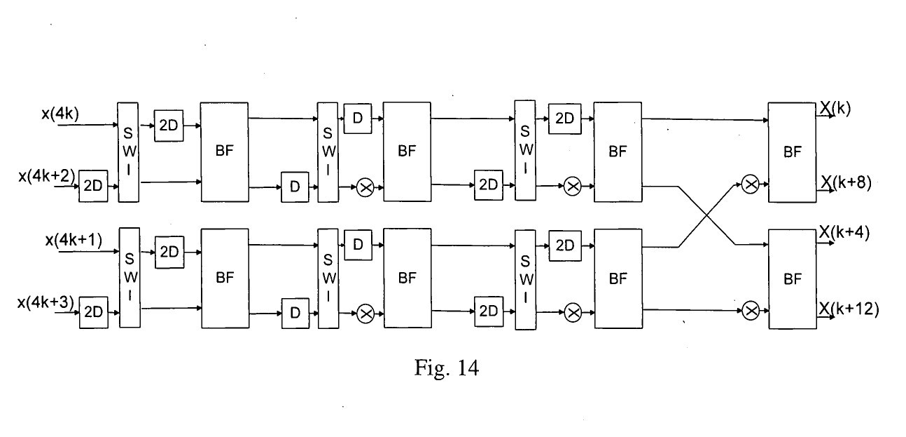

The data flow graph shown in FIG. 12 is retimed to get non-negative folded delays. The final circuit in FIG. 13 can be obtained following the same proposed approach. For a N-point FFT, the architecture takes 4(log₄ N−1) complex multipliers and 2N−4 delay elements. We can observe that hardware complexity is almost double that of the serial circuit and processes 4-samples in parallel. The power consumption can be reduced by 50% (see Section V) by lowering the operational frequency of the circuit. Similarly, a 4-parallel circuit is derived for radix-2 DIT FFT which is shown in FIG. 14.

### Radix-2² FFT Architecture

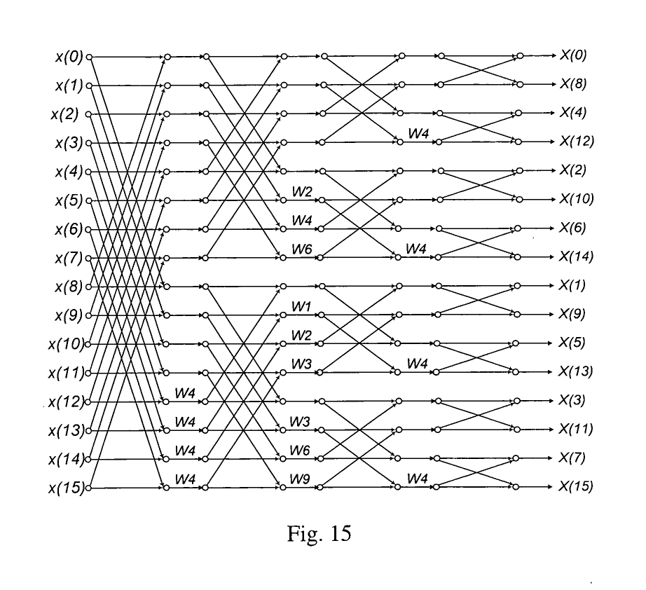

The flow graph of the radix-2² FFT algorithm is shown in FIG. 15. The advantages of radix-2² algorithm is number of required multipliers is less compared to radix-2 algorithm, which reduces the hardware complexity.

Consider the folding sets

A={A0, A2, A4, A6, A1, A3, A5, A7},

B={B5, B7, B0, B2, B4, B6, B1, B3},

C={C3, C5, C7, C0, C2, C4, C6, C1},

D={D2, D4, D6, D1, D3, D5, D7, D0} (2)

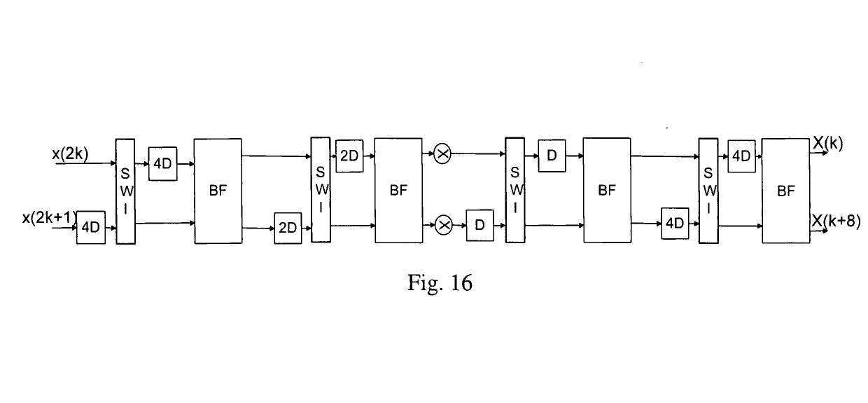

Using the folding sets above, the final circuit shown in FIG. 16 is obtained. The number of complex multipliers required for radix-2² circuit is less compared to radix-2 circuit in FIG. 9. In general, for a N-point FFT, radix-2² circuit requires 2(log₄ N−1) multipliers.

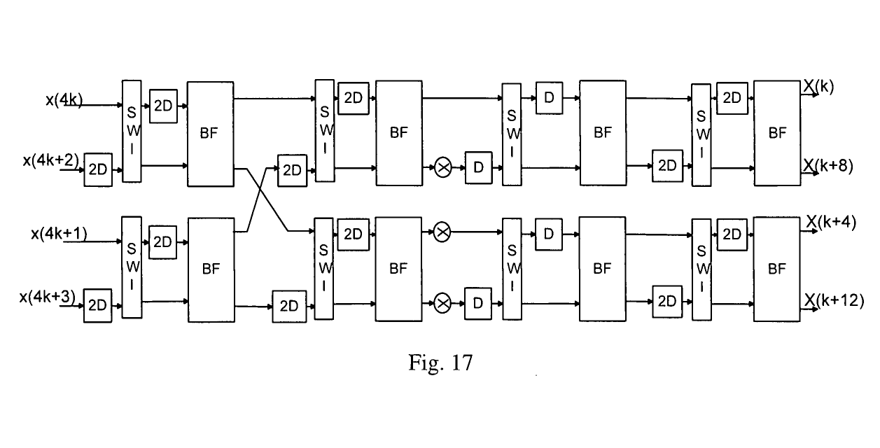

Similar to 4-parallel radix-2 circuit, we can derive 4-parallel radix-2² circuit using the similar folding sets. The 4-parallel radix-2² circuit is shown in FIG. 17. In general, for a N-point FFT, 4-parallel radix-2² circuit requires 3(log₄ N−1) complex multipliers compared 4(log₄ N−1) multipliers in radix-2 architecture. That is, the multiplier complexity is reduced by 25% compared to radix-2 circuits.

### Radix-2³ FFT Architecture

The hardware complexity in the parallel architectures can be further reduced by using radix-2ⁿ FFT algorithms. We consider the example of a 64-point radix-2³ FFT algorithm. The advantage of radix-2³ over radix-2 algorithm is its multiplicative complexity reduction. A 2-parallel circuit is derived using folding sets in (2). Here the data flow graph contains 32 nodes instead of 8 in 16-point FFT.

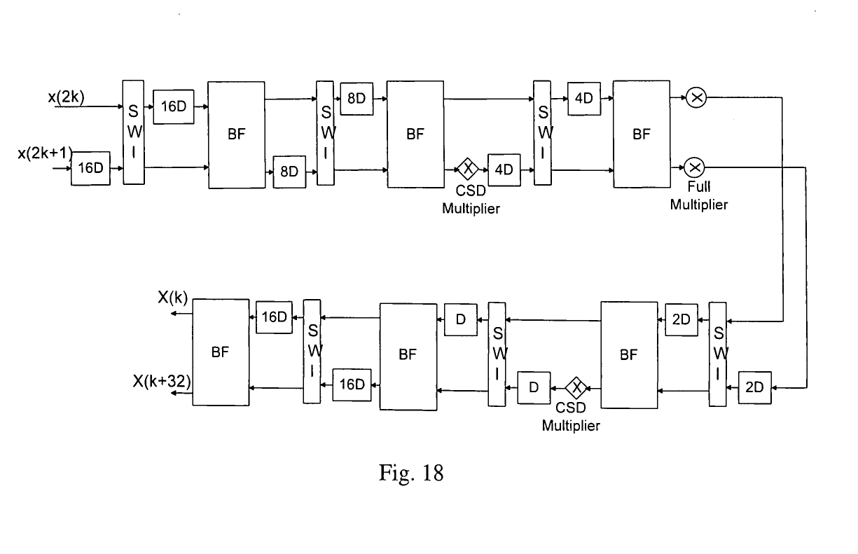

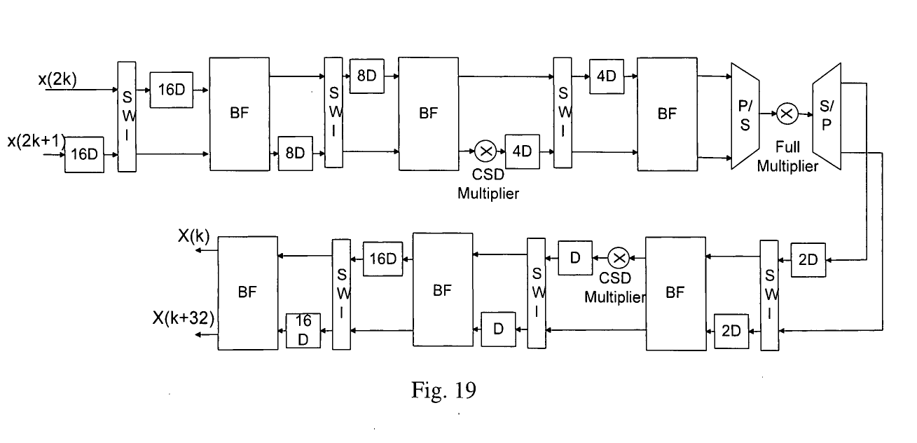

The proposed circuit is shown in FIG. 18. The design contains only two full multipliers and two constant multipliers. The constant multiplier can be implemented using Canonic Signed Digit (CSD) format with much less hardware compared to a full multiplier. For an N-point FFT, where N is a power of 2³, the proposed architecture requires 2(log₈ N−1) multipliers and 3N/2−2 delays. The multiplication complexity can be halved by computing the two operations using one multiplier. This can be seen in the modified architecture shown in FIG. 19. The only disadvantage of this design is that two different clocks are needed. The multiplier has to be operated at double the frequency compared to the rest of the design. The architecture requires only log₈ N−1 multipliers.

A 4-parallel radix-2³ circuit can be derived similar to the 4-parallel radix-2 FFT circuit. A large number of architectures can be derived using the proposed approach. Using the folding sets of same pattern, 2-parallel and 4-parallel architectures can be derived for radix-2² and radix-2⁴ algorithms. Other embodiments not shown here can be derived by a person skilled in the relevant art by using the main ideas of this invention.

### Application

It is mentioned that the proposed design is general and can be applied to any FFT size. It should be noted that the design architecture provided here are few implementations of the proposed FFT circuits using radix-2, radix-2² and radix-2³ algorithms. Other circuits for large FFT sizes (N>16) not shown here can be derived by a person skilled in the relevant art.

Next, the hardware complexity analysis is presented to demonstrate the complexity reduction of the proposed FFT circuits. Further, another analysis is presented to evaluate the performance of the circuit in terms of throughput and power consumption of the proposed FFT circuits.

To evaluate the hardware cost, the comparison is made in terms of required number of complex multipliers, adders, delay elements and twiddle factors and throughput. Table 1 shows hardware complexity comparison between the prior inventions and the proposed ones for the case of computing an N-point FFT circuits.

The proposed circuits are all feed-forward which can process 2 samples in parallel, thereby achieving a higher performance than traditional designs which are serial in nature. When compared to some prior inventions, the proposed design doubles the throughput and halves the latency while maintaining the same hardware complexity.

Next, comparison is made between the power consumption of the serial circuit similar to the one shown in FIG. 2 with the proposed parallel circuits of same radix in terms of dynamic power. The dynamic power consumption of a CMOS circuit can be estimated using the following equation,

Pₛₑᵣ=CₛₑᵣV²fₛₑᵣ, (3)

where Cₛₑᵣ denotes the total capacitance of the serial circuit, V is the supply voltage and fₛₑᵣ is the clock frequency of the circuit. Let Pₛₑᵣ denotes the power consumption of the serial architecture.

In an L-parallel system, to maintain the same sample rate, the clock frequency must be decreased to fₛₑᵣ/L. The power consumption in the L-parallel system can be calculated as

$${P}_{par} = {C}_{par} {V}^{2} \frac{{f}_{ser}}{L} , \qquad ( 4 )$$

where Cₚₐᵣ is the total capacitance of the L-parallel system.

For example, consider the proposed architecture in FIGS. 9 and R2SDF architecture. The hardware overhead of the proposed architecture is 50% increase in the number of delays. Assume the delays account for half of the circuit complexity in serial architecture. Then Cₚₐᵣ=1.25Cₛₑᵣ which leads to

$$\begin{matrix}{P}_{par} = 1.25 {C}_{ser} {V}^{2} \frac{{f}_{ser}}{2} \\ = 0.625 {P}_{ser}\end{matrix} \qquad EQ . ( 5 )$$

Therefore, the power consumption in a 2-parallel architecture has been reduced by 37% compared to the serial architecture.

Similarly, for the proposed 4-parallel architecture in FIG. 13, the hardware complexity doubles compared to R2SDF architecture. This leads to a 50% reduction in power compared to serial architecture.

### Conclusion

Various embodiments of the present invention have been described above, which are independent of the size of the FFT and/or the parallelism level. These various embodiments can be implemented in communication transceivers and spectral processing systems. These various embodiments can also be implemented in systems other than communication systems. It should be understood that these embodiments have been presented by way of example only, and not limitation.

It will be understood by those skilled in the relevant art that various changes in form and details of the embodiments described may be made without departing from the spirit and scope of the present invention as defined in the claims. Thus, the breadth and scope of present invention should not be limited by any of the above-described exemplary embodiments, but should be defined only in accordance with the following claims and their equivalents.

TABLE 1

| | # Multi- | # | # | | Through- |
|---|---|---|---|---|---|
| Architecture | pliers | Adders | Delays | Control | put |
| R2MDC | 2(log₄N − 1) | 4log₄N | 3N/2 − 2 | simple | 1 |
| R2SDF | 2(log₄N − 1) | 4log₄N | N − 1 | simple | 1 |
| R4SDC | (log₄N − 1) | 3log₄N | 2N − 2 | complex | 1 |
| R2²SDF | (log₄N − 1) | 4log₄N | N − 1 | simple | 1 |
| R2³SDF* | (log₈N − 1) | 4log₄N | N − 1 | simple | 1 |
| Proposed | | | | | |
| Architectures | | | | | |
| 2-parallel | 2(log₄N − 1) | 4log₄N | 3N/2 − 2 | simple | 2 |
| (radix-2) | | | | | |
| 4-parallel | 4(log₄N − 1) | 8log₄N | 2N − 4 | simple | 4 |
| (radix-2) | | | | | |
| 2-parallel | 2(log₄N − 1) | 4log₄N | 3N/2 − 2 | simple | 2 |
| (radix-2²) | | | | | |
| 4-parallel | 3(log₄N − 1) | 8log₄N | 2N − 4 | simple | 4 |
| (radix-2²) | | | | | |
| 2-parallel | 2(log₈N − 1) | 4log₄N | 3N/2 − 2 | simple | 2 |
| (radix-2³)* | | | | | |
| 2-parallel | log₈N − 1 | 4log₄N | 3N/2 − 2 | simple | 2 |
| (radix-2³)* | | | | | |

*These architectures need 2 constant multipliers as described in Radix-2³ algorithm

What is claimed is:

1. A 2-parallel fast Fourier transform (FFT) computation pipeline, comprising:
i. a plurality of radix-2 butterfly engines, connected in cascade, where each butterfly engine processes two samples and computes two output samples, and contains a butterfly computation unit;
ii. wherein two consecutive samples of the input sequence are input to the first butterfly engine in the same clock cycle.

2. The FFT computation pipeline of claim 1 wherein an output of a butterfly computation unit is multiplied with a twiddle factor.

3. The FFT computation pipeline of claim 1 wherein an input of a butterfly computation unit is multiplied with a twiddle factor.

4. The FFT computation pipeline in claim 1 wherein the computation unit computes the FFT in a decimation-in-time mode.

5. The FFT computation pipelined in claim 1 wherein the computation unit computes the FFT in a decimation-in-frequency mode.

6. The FFT computation pipeline in claim 1 wherein the computation unit computes the FFT in a radix-2-squared mode.

7. The FFT computation pipeline in claim 1 wherein the computation unit compute FFT in radix-2-to-the-power-i mode where i is an integer greater than 2.

8. The FFT computation pipeline in claim 1 used in a communications transceiver.

9. The FFT computation pipeline in claim 1 used in a spectral processing system.

10. The FFT computation pipeline in claim 1 wherein the butterfly engine contains a commutator to reorder samples of two signals with or without introducing delays.

11. A L-parallel fast Fourier transform (FFT) computation pipeline,where L is an integer power of 2, i.e., L=2^{k}, k is an integer greater than 1, comprising:
i. a plurality of butterfly engines with L inputs and L outputs, connected in cascade, where each butterfly engine processes L samples and computes L output samples, and contains a plurality of butterfly computation units;
ii. wherein L consecutive samples of the input sequence are input to the first butterfly engine in the same clock cycle.

12. The FFT computation pipeline of claim 11 wherein an output of a butterfly computation unit is multiplied with a twiddle factor.

13. The FFT computation pipeline of claim 11 wherein an input of a butterfly computation unit is multiplied with a twiddle factor.

14. The FFT computation pipeline in claim 11 wherein the computation unit computes the FFT in a decimation-in-time mode.

15. The FFT computation pipelined in claim 11 wherein the computation unit computes the FFT in a decimation-in-frequency mode.

16. The FFT computation pipeline in claim 11 wherein the computation unit computes the FFT in a radix-2-squared mode.

17. The FFT computation pipeline in claim 11 wherein the computation unit compute FFT in radix-2-to-the-power-i mode where i is an integer greater than 2.

18. The FFT computation pipeline in claim 11 used in a communications transceiver.

19. The FFT computation pipeline in claim 11 used in a spectral processing system.

20. The FFT computation pipeline in claim 11 wherein the butterfly engine contains a commutator to reorder samples of two signals with or without introducing delays.
